(19) United States
(12) Patent Application Publication
(10) Pub. No.: US 2024/0282303 A1
(43) Pub. Date: Aug. 22, 2024

(54) AUTOMATED CUSTOMIZATION ENGINE

(71) Applicant: JUST RIGHT READER, INC., Fort Worth, TX (US)

(72) Inventor: Sara SHENKAN, Fort Worth, TX (US)

(73) Assignee: JUST RIGHT READER, INC., Fort Worth, TX (US)

(21) Appl. No.: 18/444,440

(22) Filed: Feb. 16, 2024

Related U.S. Application Data
(60) Provisional application No. 63/446,692, filed on Feb. 17, 2023.

(51) Int. Cl. G10L 15/22; G10L 15/02; G10L 15/26

(52) U.S. Cl. CPC G10L 15/22; G10L 15/02; G10L 15/26; G10L 2015/025; G10L 2015/225

(57) ABSTRACT

A system and method can be provided for automatically generating and outputting reader feedback. For example, the method can involve receiving audio content generated by a user and corresponding to textual content provided to the user. The method can further involve comparing the received audio content to expected audio content via a machine learning algorithm. Additionally, the method can involve determining, based on an output of the machine learning algorithm, that a portion of the received audio content deviates from a portion of the expected audio content by greater than a threshold value. The method can also involve generating speech corresponding to the portion of the expected audio content. The speech corresponding to the portion of the expected audio content can be generated based on one or more attributes of the user. The method can further involve outputting the generated speech to the user.

### CROSS-REFERENCE TO RELATED APPLICATIONS

This application is based on, and claims the benefit of, U.S. Provisional Application No. 63/446,692, filed Feb. 17, 2023, and which is incorporated herein by reference in its entirety. This application is related to U.S. Provisional Application No. 63/446,703, filed Feb. 17, 2023, and to U.S. application Ser. No. 18/444,387, entitled “Automated Customization Virtual Ecosystem” (Corresponding to Attorney Docket No. 109556-1423959), and filed on Feb. 16, 2024, the entirety of each of which is hereby incorporated by reference herein.

### BACKGROUND

Interactive reading can be a dynamic approach to storytelling and education in which multi-media elements and user input are integrated to create an immersive or customizable experience. The interactive reading can be enabled by technical platforms such as eBooks, applications, websites, or virtual reality. The technical platforms can allow users to make choices that influence a story. In educational settings, the technical platforms can present educational elements such as quiz questions, animations, or other suitable elements which enhance learning experiences. It can be desirable to improve and personalize interactive reading environments, particularly in educational settings, to improve user experience and create engaging, effective digital learning environments.

### SUMMARY

Aspects of the present relate to a method for automated reader feedback. In some embodiments, the method can include receiving audio content generated by a user and corresponding to textual content provided to the user. The audio content can include read content. The method can further include comparing the received audio content to expected audio content via a machine learning algorithm. The method can include determining, based on an output of the machine learning algorithm, that a portion of the received audio content deviates from a portion of the expected audio content by greater than a threshold value. The method can also involve generating speech corresponding to the portion of the expected audio content. The speech corresponding to the portion of the expected audio content can be generated based at least on one attribute of the user. Additionally, the method can involve outputting the generated speech to the user.

In some embodiments, the output of the machine learning algorithm can be a deviation value indicative of an amount of deviation of the portion of the received audio control from the portion of the expected audio content. In some embodiments, determining that the portion of the received audio content deviates from expected audio content by greater than the threshold value comprises can include determining that the deviation value exceeds the threshold value.

In some embodiments, comparing the received audio content to the expected audio content via the machine learning algorithm can include extracting a first plurality of features from received audio content, extracting a second plurality of features from the expected audio content, and inputting the first plurality of features and the second plurality of features into the machine learning algorithm.

In some embodiments, the machine learning algorithm can be a first machine learning algorithm and the method can include inputting the first plurality of features and the second plurality of features into a second machine learning algorithm trained to identify phonemes. The method can also include outputting, by the second machine learning algorithm, a first set of phonemes for the received audio content and a second set of phonemes for the expected audio content. Additionally, the method can include identifying a number of phonemes in the first set of phonemes that are excluded from the second set of phonemes. The method can also include inputting the number of phonemes into the first machine learning algorithm.

In some embodiments, the textual content can first textual content, and the method can include transcribing, via a speech-to-text model, the received audio content into second textual content. The method can also include comparing the second textual content to the first textual content to determine a minimum number of operations to transform the second textual content into the first textual content. The method can further include inputting the minimum number of operations into the machine learning algorithm.

In some embodiments, the at least one attribute of the user can include a location.

In some embodiments, the at least one attribute of the user can include a spoken dialect.

In some embodiments, the at least one attribute of the user can include an accent.

In some embodiments, a system can comprise a processor and a memory that includes instructions executable by the processor for causing the processor to perform operations related to automated reader feedback. In some embodiments, the operations can include receiving audio content generated by a user and corresponding to textual content provided to the user. The audio content can include read content. The operations can further include comparing the received audio content to expected audio content via a machine learning algorithm. The operations can include determining, based on an output of the machine learning algorithm, that a portion of the received audio content deviates from a portion of the expected audio content by greater than a threshold value. The operations can also involve generating speech corresponding to the portion of the expected audio content. The speech corresponding to the portion of the expected audio content can be generated based at least on one attribute of the user. Additionally, the operations can include outputting the generated speech to the user.

In some embodiments, a non-transitory computer-readable medium can include instructions that are executable by a processor for causing the processor to perform operations related to automated reader feedback. In some embodiments, the operations can include receiving audio content generated by a user and corresponding to textual content provided to the user. The audio content can include read content. The operations can further include comparing the received audio content to expected audio content via a machine learning algorithm. The operations can include determining, based on an output of the machine learning algorithm, that a portion of the received audio content deviates from a portion of the expected audio content by greater than a threshold value. The operations can also involve generating speech corresponding to the portion of the expected audio content. The speech corresponding to the portion of the expected audio content can be generated based at least on one attribute of the user. Additionally, the operations can include outputting the generated speech to the user.

### BRIEF DESCRIPTION OF THE DRAWINGS

The present disclosure is described in conjunction with the appended figures:

FIG. 1 is a block diagram showing illustrating an example of a content customization and delivery system.

FIG. 2 is a block diagram illustrating a computer server and computing environment within the content customization and delivery system.

FIG. 3 is a block diagram illustrating an embodiment of one or more content management servers within the content customization and delivery system.

FIG. 4 is a block diagram illustrating the physical and logical components of a special-purpose computer device within the content customization and delivery system.

FIG. 5 is a flowchart illustrating one embodiment of a process for book customization.

FIG. 6 is a flowchart illustrating a process for creating a social-networked content distribution system.

FIG. 7 is a flowchart illustrating one embodiment of a process for automated reader feedback.

FIG. 8 is a flowchart illustrating one embodiment of a process for generating and providing a living book.

In the appended figures, similar components and/or features may have the same reference label. Where the reference label is used in the specification, the description is applicable to any one of the similar components having the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides illustrative embodiment(s) only and is not intended to limit the scope, applicability or configuration of the disclosure. Rather, the ensuing description of the illustrative embodiment(s) will provide those skilled in the art with an enabling description for implementing a preferred exemplary embodiment. It is understood that various changes can be made in the function and arrangement of elements without departing from the spirit and scope as set forth in the appended claims.

In some embodiments, a method can be performed to provide automated reader feedback. For example, the method can involve receiving audio content generated by a user and corresponding to textual content provided to the user. The method can further involve comparing the received audio content to expected audio content via a machine learning algorithm. Additionally, the method can involve determining, based on an output of the machine learning algorithm, that a portion of the received audio content deviates from a portion of the expected audio content by greater than a threshold value. The method can also involve generating speech corresponding to the portion of the expected audio content and outputting the generated speech to the user. The speech corresponding to the portion of the expected audio content can be generated based at least on one attribute of the user.

By receiving audio content generated by a user and determining that a portion of the received audio content deviates from a portion of expected audio content via the machine learning algorithm, a personalized, adaptive method of generating user feedback can be provided. For example, when a user is reading aloud, the audio content can be received. Then, if, for example, a word read aloud by the user is pronounced incorrectly, the machine learning model can facilitate identification of a portion of the received audio content corresponding to the word as deviating from the expected audio content. Thus, the mispronunciation or other suitable deviations can be detected in an efficient manner, and in some examples, substantially contemporaneous to the word being read aloud.

The personalization of the feedback can then be enhanced by generating speech based off at least one attribute of the user (e.g., a location, language, dialect, accent, or other suitable attribute). That is, the feedback can sound similar to the user or similar to people associated with (e.g., within a similar location as) the user. In some examples, a pitch, timbre, speech rate or rhythm, or other suitable characteristics of the user's voice can be mimicked to cause the generated speech to sound similar to the user. In this way, a comprehensibility of the generated speech output to the user can be improved, which can further improve an ability of the user to reproduce the generated speech (e.g., by correctly pronouncing the word).

Additionally, an accuracy of the feedback can be enhanced by generating speech based off at least one attribute of the user. For example, by generating the speech based on a dialect, region, or other suitable attribute of the user, the feedback (e.g., the generated speech of the expected content) can take into account pronunciation differences or other suitable language characteristics relevant to the user. In particular, the feedback can be more accurate than, for example, a standard pronunciation for a language, since the standard pronunciation may not account for dialect, region, or other suitable attributes of the user that that affect written or spoken language. Thus, by identifying audio content which deviates from expected content and outputting generated, personalized speech to demonstrate the expected content, user learning can be enhanced.

Furthermore, audio content can be received and processed (e.g., input into the machine learning algorithm), and speech can be generated and output via an input/output (I/O) system associated with a book, eBook, or other suitable piece of content. Thus, the automated feedback can be provided to users of printed books. Additionally, in examples in which the user is using an eBook, the automated feedback can be provided without interrupting operations of the device from which the eBook is accessed (e.g., other interactive elements of the eBook).

In some embodiments, the output of the machine learning algorithm can be a deviation value indicative of an amount of deviation of the portion of the received audio control from the portion of the expected audio content. In such embodiments, determining that portion of the received audio content deviates from expected audio content by greater than the threshold value can involve determining that the deviation value exceeds the threshold value.

In some embodiments, comparing the received audio content to the expected audio content via the machine learning algorithm can involve extracting a first plurality of features from received audio content, extracting a second plurality of features from the expected audio content, and inputting the first plurality of features and the second plurality of features into the machine learning algorithm.

In some embodiments, the machine learning algorithm can be a first machine learning algorithm and the method can involve inputting the first plurality of features and the second plurality of features into a second machine learning algorithm trained to identify phonemes. The method can then involve outputting, by the second machine learning algorithm, a first set of phonemes for the received audio content and a second set of phonemes for the expected audio content, identifying a number of phonemes in the first set of phonemes that are excluded from the second set of phonemes, inputting the number of phonemes into the first machine learning algorithm.

In some embodiments, the textual content can be first textual content, and the method can involve transcribing, via a speech-to-text model, the received audio content into second textual content. Then, the method can involve comparing the second textual content to the first textual content to determine a minimum number of operations to transform the second textual content into the first textual content and inputting the minimum number of operations into the machine learning algorithm.

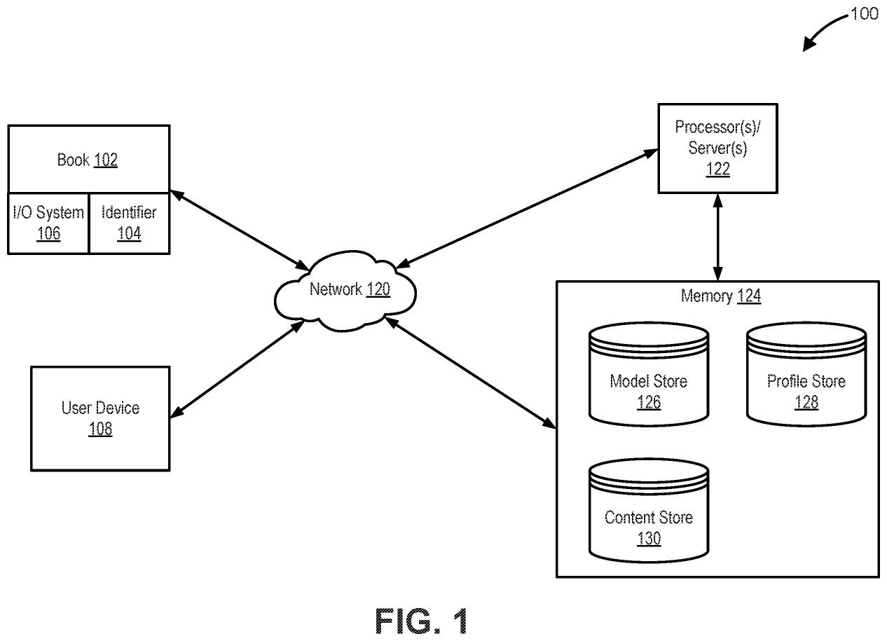

In some embodiments, the at least one attribute of the user can include a location, spoken dialect, or an accent. With reference now to FIG. 1, a block diagram is shown illustrating various components of a content customization and delivery system 100 which implements and supports certain embodiments and features described herein. The content customization and delivery system 100 may include one or more books 102. Some or all of the one or more books 102 can comprise a physical, printed book, or can comprise an eBook. Thus, the books 102 can comprise written content, which can be embodied in a digital format or in a printed format.

In some embodiments in which the book 102 comprises a printed book, the book 102 can include an identifier 104. The identifier 104 can comprise a computer readable identifier, which can be, for example, a computer readable code. In some embodiments, the computer readable code can be a barcode such as a 1D barcode (e.g., a universal product code (UPC)), a 2D barcode (e.g., aa Quick Response (QR) code), a 3D barcode, or the like. In some embodiments, the computer readable identifier can comprise an electronic identifier such as a radio-frequency identification (RFID) tag, a near field communication (NFC) tag, or the like.

In some embodiments, the book 102 can include one or several features configured to assist the user in reading the book. These features can include an Input/output system (I/O system) 106. The I/O system can include, for example, one or several speakers, microphones, cameras, or the like. In some embodiments, the I/O system 106 can be configured generate data while the user is reading the book, and in some embodiments, the I/O system 106 can evaluate the user's reading and provide feedback to the user.

In some embodiments, the book 102 can comprise a processor. In some embodiments, the processor can include one or several microprocessors, such as one or several Central Processing Units (CPUs), one or several Graphics Processing Units (GPUs), or a combination thereof. The processor can be a commercially available microprocessor from Intel®, Advanced Micro Devices, Inc.®, Nvidia Corporation®, or the like.

The processor can be communicatively coupled with memory. The memory can comprise stored instructions in the form of computer code, that when executed by the processor and/or the controller, cause the processor and/or controller to take one or several actions. The memory can comprise primary and/or secondary memory. The memory can include, for example, cache memory, RAM, ROM, PROM, EPROM, EEPROM, one or several solid-state drives (SSD), one or several hard drives or hard disk drives, or the like. Thus, in some embodiments, the memory can include volatile and/or non-volatile memory.

In some embodiments, the instructions in the memory can control the processor to receive information via the I/O system 106, to process that information, and to provide an output. For example, the processor can receive sound via a speaker. The sound can be speech from a user reading the written content of the book 102 out loud. The processor can further evaluate aspects of the speech including, for example, an accuracy of the words read out loud with respect to the written content, pronunciation of the words with respect to the written content, a speed at which each word in the written content is spoken, a pace or rhythm of the speech, stress patterns of the speech, intonation of the speech, or the like. Additionally, based on evaluating aspects of the speech, the processor can provide feedback to the user via the I/O system 106. In some embodiments, this feedback can include generated speech of the written content which is played back to the user via the speaker. For example, the processor can identify one or more words which the user pronounced incorrectly, one or more sentences that the user took more than a threshold time to read out loud, or a combination thereof. Thus, the generated speech can include the words or sentences which the processor identified. Thus, the processor can provide corrective instruction to the user.

The system 100 can include a user device 108. The user device 108 may display content received from the user, from other components in the system 100, or a combination thereof, and may support various types of user interactions with the content. User devices 108 may include mobile devices such as smartphones, tablet computers, personal digital assistants, and wearable computing devices. Such mobile devices may run a variety of mobile operating systems and may be enabled for Internet, e-mail, short message service (SMS), Bluetooth®, mobile radio-frequency identification (M-RFID), and/or other communication protocols. Other user devices 108 may be general purpose personal computers or special-purpose computing devices including, by way of example, personal computers, laptop computers, workstation computers, projection devices, and interactive room display systems. Additionally, user devices 108 may be any other electronic devices, such as a thin-client computers, Internet-enabled gaming systems, business or home appliances, and/or personal messaging devices, capable of communicating over a network(s).

In different contexts of system 100, user devices 108 may correspond to different types of specialized devices, for example, student devices and teacher devices in an educational network, employee devices and presentation devices in a company network, different gaming devices in a gaming network, etc. In some embodiments, a plurality of user devices 108 may operate in the same physical location, such as a classroom or conference room. In such cases, the devices may contain components that support direct communications with other nearby devices, such as wireless transceivers and wireless communications interfaces, Ethernet sockets or other Local Area Network (LAN) interfaces, etc. In other implementations, the user devices 108 need not be used at the same location, but may be used in remote geographic locations in which each user device 108 may use security features and/or specialized hardware (e.g., hardware-accelerated SSL and HTTPS, WS-Security, firewalls, etc.) to communicate with other components of the system 100.

In some embodiments, the system 100 may include one or more communication networks 120. Although only a single network 120 is identified in FIG. 1, the system 100 may include any number of different communication networks between any of the computer servers and devices shown in FIG. 1 and/or other devices described herein. Communication networks 120 may enable communication between the various computing devices, servers, and other components of the system 100. As discussed below, various implementations of system 100 may employ different types of networks 120, for example, computer networks, telecommunications networks, wireless networks, and/or any combination of these and/or other networks.

The system 100 may include one or several navigation systems or features including, for example, the Global Positioning System (“GPS”), GALILEO (e.g., Europe's global positioning system), or the like, or location systems or features including, for example, one or several transceivers that can determine location of the one or several components of the system 100 via, for example, triangulation. These navigation systems can be included as part of the network 120.

In some embodiments, network 120 can include or several features that can communicate with one or several components of the system 100 including, for example, with one or several of the user devices 108, with one or several books 102, or a combination thereof. In some embodiments, this communication can include the transmission of a signal from the navigation system which signal is received by one or several components of the system 100 and can be used to determine the location of the one or several components of the system 100.

The system 100 can include one or several processors and/or servers 122. In some embodiments, the one or several processors and/or servers 122 can be configured to communicate with the book 102, the user device 108, or a combination thereof. For example, the processors and/or servers 122 can receive one or several communications from the book 102, the user device 108, or the combination thereof. Additionally or alternatively, the processors and/or servers 122 can send one or several communications to the book 102, to the user device 108, or the combination thereof. In some embodiments, the processors and/or servers can receive data relating to a user from the book 102, the user device 108, or the combination thereof. The processors and/or servers 122 may also provide content to the user via the book 102, the user device 108, or the combination thereof. In some embodiments, information relating to the user, such as which written content the user has consumed, user performance in consuming the written content, or a user skill level can be received by the processors and/or servers 122, from the book 102, the user device 108, or the combination thereof. In some embodiments, the processors and/or servers 122 can, based on the received information, identify an updated user skill level, update a user profile, content for providing to the user, and/or provide content to the user.

The processor 122 can include, in some embodiments, one or several servers. The one or several servers can be any desired type of server including, for example, a rack server, a tower server, a miniature server, a blade server, a mini rack server, a mobile server, an ultra-dense server, a super server, or the like, and may include various hardware components, for example, a motherboard, a processing unit, memory systems, hard drives, network interfaces, power supplies, etc. The servers 122 may include one or more server farms, clusters, or any other appropriate arrangement and/or combination or computer servers. The processor and/or servers 122 may act according to stored instructions located in a memory subsystem of the server 122, and may run an operating system, including any commercially available server operating system and/or any other operating systems discussed herein.

The processor 122 can be communicatively coupled with memory 124. The memory 124, also referred to herein as a database server can access data that can be stored on a variety of hardware components. These hardware components can include, for example, components forming tier 0 storage, components forming tier 1 storage, components forming tier 2 storage, and/or any other tier of storage. In some embodiments, tier 0 storage refers to storage that is the fastest tier of storage in the database server 124, and particularly, the tier 0 storage is the fastest storage that is not RAM or cache memory. In some embodiments, the tier 0 memory can be embodied in solid state memory such as, for example, a solid-state drive (SSD) and/or flash memory.

In some embodiments, the tier 1 storage refers to storage that is one or several higher performing systems in the memory management system, and that is relatively slower than tier 0 memory, and relatively faster than other tiers of memory. The tier 1 memory can be one or several hard disks that can be, for example, high-performance hard disks. These hard disks can be one or both of physically or communicatively connected such as, for example, by one or several fiber channels. In some embodiments, the one or several disks can be arranged into a disk storage system, and specifically can be arranged into an enterprise class disk storage system. The disk storage system can include any desired level of redundancy to protect data stored therein, and in one embodiment, the disk storage system can be made with grid architecture that creates parallelism for uniform allocation of system resources and balanced data distribution.

In some embodiments, the tier 2 storage refers to storage that includes one or several relatively lower performing systems in the memory management system, as compared to the tier 1 and tier 2 storages. Thus, tier 2 memory is relatively slower than tier 1 and tier 0 memories. Tier 2 memory can include one or several SATA-drives or one or several NL-SATA drives.

In some embodiments, the one or several hardware and/or software components of the database server 124 can be arranged into one or several storage area networks (SAN), which one or several storage area networks can be one or several dedicated networks that provide access to data storage, and particularly that provides access to consolidated, block level data storage. A SAN typically has its own network of storage devices that are generally not accessible through the local area network (LAN) by other devices. The SAN allows access to these devices in a manner such that these devices appear to be locally attached to the user device.

Databases may comprise stored data relevant to the functions of the system 100. In some embodiments, multiple databases may reside on a single database server 124, either using the same storage components of data server 124 or using different physical storage components to assure data security and integrity between databases. In other embodiments, each database may have a separate dedicated database server 124.

The memory 124 can comprise one or several databases which can store information used by processor 122. These databases can include, for example, a model store 126, a profile store 128, and a content store 130. In some embodiments, the model store 126 can store one or several machine learning models which can be configured to generate one or several predictions and/or to generate one or several outputs. In some embodiments, these models can include, for example, a model configured to predict a user skill level, a model configured to convert user speech to text and/or to analyze user speech, a model configured to generate speech, a model configured to generate one or several avatars including, for example, a virtual teacher, a model configured to identify one or several user interests, or the like.

The profile store 128 can include information relating to one or several user profiles. This information can include, for example, information relating to the users' personal contacts such as family member personal data (e.g., name, age, etc.) and contact information (e.g., phone number, email, etc.), personal data and contact information for friends, or a combination thereof. The information can further include information relating to the users' interests such as hobbies, reading content preferences (e.g., genre or literary format preferences), learning preferences, activities, or the like. In some embodiments, the user profile can include links to user profiles of the users' personal contacts or other suitable friends or family for which there are user profiles. Thus, in some embodiments, the profile store 128 can include information creating a social network of users.

The profile store 128 may include information relating to the end users within the system 100. Generally speaking, the profile store 128 can be a database having restrictions on access. The restrictions can govern whether one or several users or categories of users are able to perform one or several actions on the database or on data stored in the database. In some embodiments, the profile store 128 can include any information for which access is restricted. This information may include user personal data, user characteristics such as the usernames, access credentials (e.g., logins and passwords), user preferences, and information relating to any previous user interactions within the system 100 (e.g., requested content, posted content, content modules completed, training scores or evaluations, other associated users, etc.). In some embodiments, this information can relate to one or several individual end users such as, for example, one or several students, teachers, administrators, or the like, and in some embodiments, this information can relate to one or several institutional end users such as, for example, one or several schools, groups of schools such as one or several school districts, one or several colleges, one or several universities, one or several training providers, or the like.

In some embodiments, the profile store 128 can include information relating to a categorization of one or several users, and specifically relating to an access categorization of one or several users. In some embodiments, the categorizations of the one or several users can indicate the type of data that the user is allowed to access. Additionally or alternatively, the categorizations can indicate the degree to which the user can access, edit, retrieve, and/or provide data. The access classifications can relate to the level of responsibility of the user to enable the user to access data relevant and useful to their responsibility. In some embodiments, this data can include personal information collected from one or several individuals such as students, employees, patients, or the like. In embodiments in which this data relates to one or several students associated with the system 100, these one or several students can be, for example, one or several students taking classes via an institutional user of the content customization and delivery system 100. In some embodiments, the categories can include, for example, a trusted entity, a first tier administrator, a second tier administrator, a third tier administrator, an instructor, a guardian, and/or a student.

In some embodiments, the trusted entity can be allowed to access all data contained within the system 100, and the first tier administrator can be able to access data contained within the system 100 relating to a first tier describing a largest level of a political entity such as a school district, a university, a healthcare network, or the like. In some embodiments, the second tier administrator is able to access a subset of the data contained within the system 100 relating to the first tier, alternatively described as all of the data relating to the second tier describing a sub-level of the political entity such as a school within a school district, a college within a university, a healthcare service provider such as, for example, a clinic or a hospital, in the healthcare network, or the like. In some embodiments, the third tier administrator is able to access a subset of the data contained within the content customization and delivery system 100 relating to the second tier, alternatively described as all of the data relating to the third tier describing a sub-level of the sub-level political entity such as, for example, a department within a school or a college, a group within a healthcare service provider, or the like. In some embodiments, the instructor can be, for example, a healthcare provider such as a doctor or a nurse, a teacher, or the like. The instructor can have access to data relating to, for example, courses or sections taught by the teacher, or patients of the healthcare provider. In some embodiments, the guardian can be an individual with legal responsibility for one or several students or patients and can thus have access to data relating to those one or several students or patients. In some embodiments, the student can be a patient or a student in a course, and can have access to their own information.

In some embodiments in which the one or several end users are individuals, and specifically are students, the profile store 128 can further include information relating to these students' academic history. This information can identify one or several courses of study that the student has initiated, completed, and/or partially completed, as well as grades received in those courses of study. In some embodiments, the student's academic history can further include information identifying student performance on one or several tests, quizzes, and/or assignments. In some embodiments, this information can be stored in a tier of memory that is not the fastest memory in the system 100.

The profile store 128 can include information relating to one or several student learning preferences. In some embodiments, for example, the student may have one or several preferred learning styles, one or several most effective learning styles, or the like. In some embodiments, the learning styles can be any learning style describing how the student best learns or how the student prefers to learn. For example, the learning styles can include auditory learning, visual learning, tactile learning, Thus, a student may be identified as an auditory learner, as a visual learner, as a tactile learner, or a combination thereof. In some embodiments, the data identifying one or several student learning styles can include data identifying a learning style based on the student's educational history such as, for example, identifying a student as an auditory learner when the student has received significantly higher grades and/or scores on assignments and/or in courses favorable to auditory learners. In some embodiments, this information can be stored in a tier of memory that is not the fastest memory in the system 100.

The profile store 128 can further include information relating to one or several teachers or instructors who are responsible for organizing, presenting, and/or managing the presentation of information to students. In some embodiments, profile store 128 can include information identifying courses and/or subjects that have been taught by the teacher, data identifying courses, or subjects, or a combination thereof currently taught by the teacher, and/or data identifying courses, subjects, or the combination thereof that will be taught by the teacher (e.g., during a subsequent school year or semester). In some embodiments, this can include information relating to one or several teaching styles of one or several teachers. In some embodiments, the profile store 128 can further include information indicating past evaluations or evaluation reports received by the teacher. In some embodiments, the profile store 128 can further include information relating to improvement suggestions received by the teacher, training received by the teacher, continuing education received by the teacher, and/or the like. In some embodiments, this information can be stored in a tier of memory that is not the fastest memory in the system 100.

The content store 130 can include content for presentation to one or several users. In some embodiments, this content can include text, images, animations, video, audio, or the like. In some embodiments, this content can be customized to a user based on information contained in the user profile, such as, for example, user interests, user contacts, and/or user skill level.

In some embodiments, the content store 130 may include information describing the individual content items (or content resources) available via the system 100. In some embodiments, the content store 130 may include metadata, properties, and other characteristics associated with the content resources. In some embodiments, the content items can include the one or several items that can include one or several documents and/or one or several applications or programs. For example, the one or several items can include one or several webpages, presentations, papers, videos, charts, graphs, books, written work, figures, images, graphics, recordings, or any other document, or any desired software or application or component thereof including, for example, a graphical user interface (GUI), all or portions of a Learning Management System (LMS), all or portions of a Content Management System (CMS), all or portions of a Student Information Systems (SIS), or the like.

In some embodiments, the data in the content store 130 may identify one or more aspects or content attributes of the associated content resources, for example, subject matter, access level, or skill level of the content resources, license attributes of the content resources (e.g., any limitations and/or restrictions on the licensable use and/or distribution of the content resource), price attributes of the content resources (e.g., a price and/or price structure for determining a payment amount for use or distribution of the content resource), rating attributes for the content resources (e.g., data indicating the evaluation or effectiveness of the content resource), and the like. In some embodiments, the content store 130 may be configured to allow updating of content metadata or properties, and to allow the addition and/or removal of information relating to the content resources. In some embodiments, the content store 130 can be organized such that content is associated with one or several courses and/or programs in which the content is used and/or provided. In some embodiments, the content store 130 can further include one or several teaching materials used in the course, a syllabus, one or several practice problems, one or several tests, one or several quizzes, one or several assignments, or the like. All or portions of the content library database can be stored in a tier of memory that is not the fastest memory in the system 100.

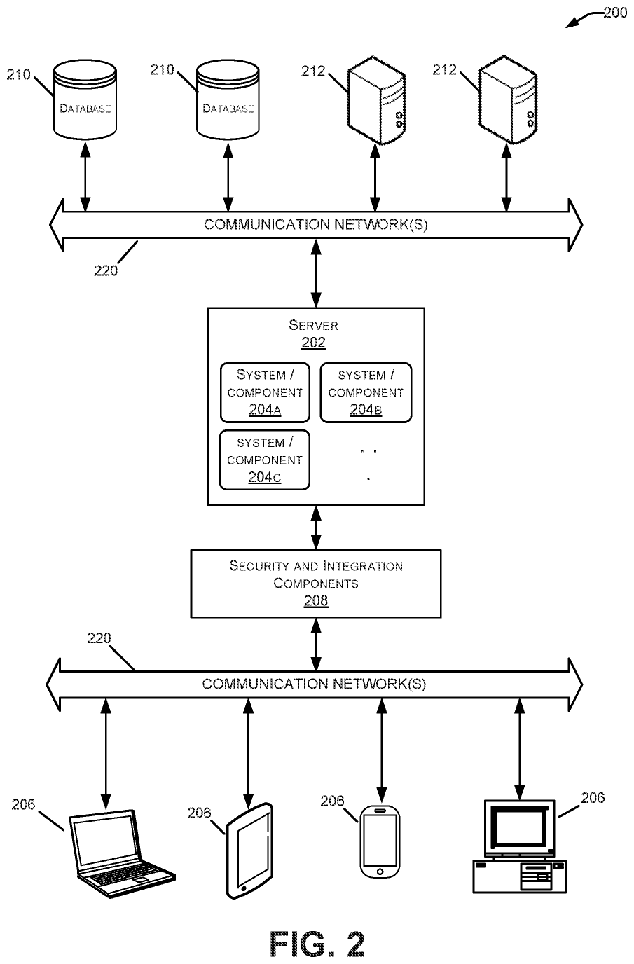

With reference to FIG. 2, an illustrative distributed computing environment 200 is shown including a computer server 202, four client computing devices 206, and other components that may implement certain embodiments and features described herein. In some embodiments, the server 202 may correspond to the server 122 discussed above in FIG. 1, and the client computing devices 206 may correspond to the user devices 108. However, the computing environment 200 illustrated in FIG. 2 may correspond to any other combination of devices and servers configured to implement a client-server model or other distributed computing architecture.

Client devices 206 may be configured to receive and execute client applications over one or more networks 220. Such client applications may be web browser-based applications and/or standalone software applications, such as mobile device applications. Server 202 may be communicatively coupled with the client devices 206 via one or more communication networks 220. Client devices 206 may receive client applications from server 202 or from other application providers (e.g., public or private application stores). Server 202 may be configured to run one or more server software applications or services, for example, web-based or cloud-based services, to support content distribution and interaction with client devices 206. Users operating client devices 206 may in turn utilize one or more client applications (e.g., virtual client applications) to interact with server 202 to utilize the services provided by these components.

Various different subsystems and/or components 204 may be implemented on server 202. Users operating the client devices 206 may initiate one or more client applications to use services provided by these subsystems and components. The subsystems and components within the server 202 and client devices 206 may be implemented in hardware, firmware, software, or combinations thereof. Various different system configurations are possible in different distributed computing systems 200 and content customization and delivery systems 100. The embodiment shown in FIG. 2 is thus one example of a distributed computing system and is not intended to be limiting.

Although exemplary computing environment 200 is shown with four client computing devices 206, any number of client computing devices may be supported. Other devices, such as specialized sensor devices, etc., may interact with client devices 206 and/or server 202.

As shown in FIG. 2, various security and integration components 208 may be used to send and manage communications between the server 202 and user devices 206 over one or more communication networks 220. The security and integration components 208 may include separate servers, such as web servers or authentication servers, and/or specialized networking components, such as firewalls, routers, gateways, load balancers, or the like. In some cases, the security and integration components 208 may correspond to a set of dedicated hardware and/or software operating at the same physical location and under the control of same entities as server 202. For example, components 208 may include one or more dedicated web servers and network hardware in a datacenter or a cloud infrastructure. In other examples, the security and integration components 208 may correspond to separate hardware and software components which may be operated at a separate physical location and/or by a separate entity.

Security and integration components 208 may implement various security features for data transmission and storage, such as authenticating users and restricting access to unknown or unauthorized users. In various implementations, security and integration components 208 may provide, for example, a file-based integration scheme or a service-based integration scheme for transmitting data between the various devices in the content customization and delivery system 100. Security and integration components 208 also may use secure data transmission protocols and/or encryption for data transfers, for example, File Transfer Protocol (FTP), Secure File Transfer Protocol (SFTP), and/or Pretty Good Privacy (PGP) encryption.

In some embodiments, one or more web services may be implemented within the security and integration components 208 and/or elsewhere within the content customization and delivery system 100. Such web services, including cross-domain and/or cross-platform web services, may be developed for enterprise use in accordance with various web service standards, such as the Web Service Interoperability (WS-I) guidelines. For example, some web services may use the Secure Sockets Layer (SSL) or Transport Layer Security (TLS) protocol to provide secure connections between the server 202 and user devices 206. SSL or TLS may use HTTP or HTTPS to provide authentication and confidentiality. In other examples, web services may be implemented using the WS-Security standard, which provides for secure SOAP messages using

XML encryption. In other examples, the security and integration components 208 may include specialized hardware for providing secure web services. For example, security and integration components 208 may include secure network appliances having built-in features such as hardware-accelerated SSL and HTTPS, WS-Security, and firewalls. Such specialized hardware may be installed and configured in front of any web servers, so that any external devices may communicate directly with the specialized hardware.

Communication network(s) 220 may be any type of network familiar to those skilled in the art that can support data communications using any of a variety of commercially-available protocols, including without limitation, TCP/IP (transmission control protocol/Internet protocol), SNA (systems network architecture), IPX (Internet packet exchange), Secure Sockets Layer (SSL) or Transport Layer Security (TLS) protocols, Hyper Text Transfer Protocol (HTTP) and Secure Hyper Text Transfer Protocol (HTTPS), and the like. Merely by way of example, network(s) 220 may be local area networks (LAN), such as one based on Ethernet, Token-Ring and/or the like. Network(s) 220 also may be wide-area networks, such as the Internet. Networks 220 may include telecommunication networks such as a public switched telephone networks (PSTNs), or virtual networks such as an intranet or an extranet. Infrared and wireless networks (e.g., using the Institute of Electrical and Electronics (IEEE) 802.11 protocol suite or other wireless protocols) also may be included in networks 220.

Computing environment 200 also may include one or more databases 210 and/or back-end servers 212. In certain examples, the databases 210 may correspond to database server(s) 124, the local data server 109, and/or the customizer data server 128 discussed above in FIG. 1, and back-end servers 212 may correspond to the various back-end servers. Databases 210 and servers 212 may reside in the same datacenter or may operate at a remote location from server 202. In some cases, one or more databases 210 may reside on a non-transitory storage medium within the server 202. Other databases 210 and back-end servers 212 may be remote from server 202 and configured to communicate with server 202 via one or more networks 220. In certain embodiments, databases 210 and back-end servers 212 may reside in a storage-area network (SAN).

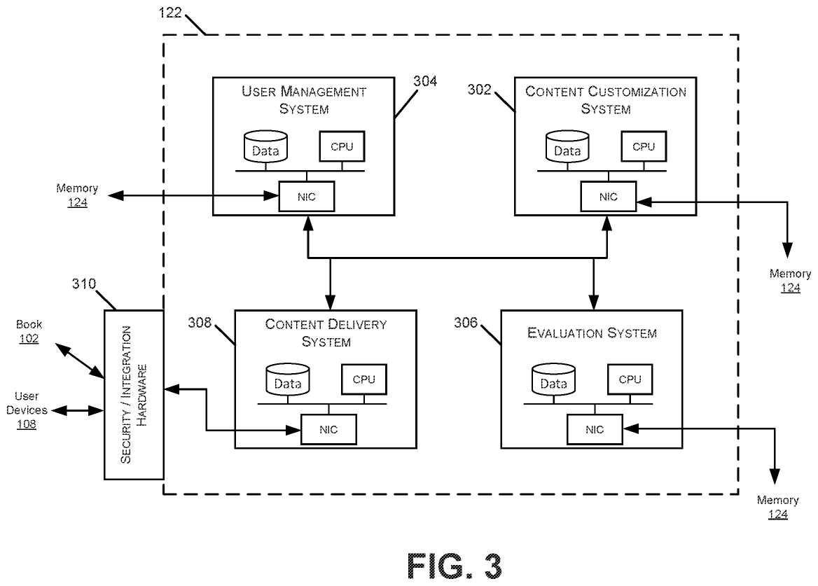

With reference now to FIG. 3, a block diagram is shown illustrating an embodiment of one or more servers 122 within the content customization and delivery system 100. As discussed above, servers 122 may include various server hardware and software components that manage the content resources within the system 100 and provide interactive and adaptive content to users on various user devices 108 and/or books 102. For example, servers 122 may provide instructions to and receive information from the other devices within the system 100, in order to manage and transmit content resources, user data, and server or client applications executing within the system 100.

A server 122 may include a content customization system 302. The content customization system 302 may be implemented using dedicated hardware within the system 100 (e.g., a content customization system 302), or using designated hardware and software resources within a shared server 122. In some embodiments, the content customization system 302 may adjust the selection and adaptive capabilities of content resources to match the needs and desires of the users receiving the content. For example, the content customization system 302 may query memory 124 to retrieve user information, such as user preferences and characteristics (e.g., from a user profile database 128), and the like. Based on the retrieved information from memory 124 and other data sources, the content customization system 302 may modify content resources for individual users.

The server 122 also may include a user management system 304. The user management system 304 may be implemented using dedicated hardware within the system 100 (e.g., a user management system 304), or using designated hardware and software resources within a shared server 122. In some embodiments, the user management system 304 may monitor the progress of users through various types of content resources and groups, such as media compilations, courses or curriculums in training or educational contexts, interactive gaming environments, and the like. For example, the user management system 304 may query memory 124 to retrieve user data such as associated content compilations or programs, content completion status, user goals, results, and the like.

The server 122 also may include an evaluation system 306. The evaluation system 306 may be implemented using dedicated hardware within the system 100 (e.g., an evaluation system 306), or using designated hardware and software resources within a shared server 122. The evaluation system 306 may be configured to receive and analyze information from books 102 and/or user devices 108. For example, various ratings of content resources submitted by users may be compiled and analyzed, and then stored in a database (e.g., the content store 130) associated with the content. In some embodiments, the evaluation system 306 may analyze the information to determine the effectiveness or appropriateness of content resources with, for example, a subject matter, an age group, a skill level, or the like. In some embodiments, the evaluation system 306 may provide updates to the content customization system 302 or the user management system 304, with the attributes of one or more content resources or groups of resources within the system 100. The evaluation system 306 also may receive and analyze user evaluation data from books 102, user devices 108, a combination thereof, or the like. For instance, evaluation system 306 may receive, aggregate, and analyze user evaluation data for different types of users (e.g., end users, supervisors, administrators, etc.) in different contexts (e.g., media consumer ratings, trainee or student comprehension levels, teacher effectiveness levels, gamer skill levels, etc.).

The server 122 also may include a content delivery system 308. The content delivery system 308 may be implemented using dedicated hardware within the system 100 (e.g., a content delivery system 308), or using designated hardware and software resources within a server 122. The content delivery system 308 may receive content resources from the content customization system 302, the user management system 304, or a combination thereof. The content delivery system 308 may further provide the resources to books 102, user devices 108, or a combination thereof. The content delivery system 308 may determine the appropriate presentation format for the content resources based on the user characteristics and preferences, the device capabilities of books 102 or user devices 108, or a combination thereof. If needed, the content delivery system 308 may convert the content resources to the appropriate presentation format and/or compress the content before transmission. In some embodiments, the content delivery system 308 may also determine the appropriate transmission media and communication protocols for transmission of the content resources.

In some embodiments, the content delivery system 308 may include a security and integration layer 310 with specialized security and integration hardware, along with corresponding software components to implement the appropriate security features content transmission and storage, to provide the supported network and client access models, and to support the performance and scalability requirements of the system 100. The security and integration layer 310 may include some or all of the security and integration components 208 discussed above in FIG. 2, and may control the transmission of content resources and other data, as well as the receipt of requests and content interactions, to and from the books 102, the user devices 108, or other devices in the system 100.

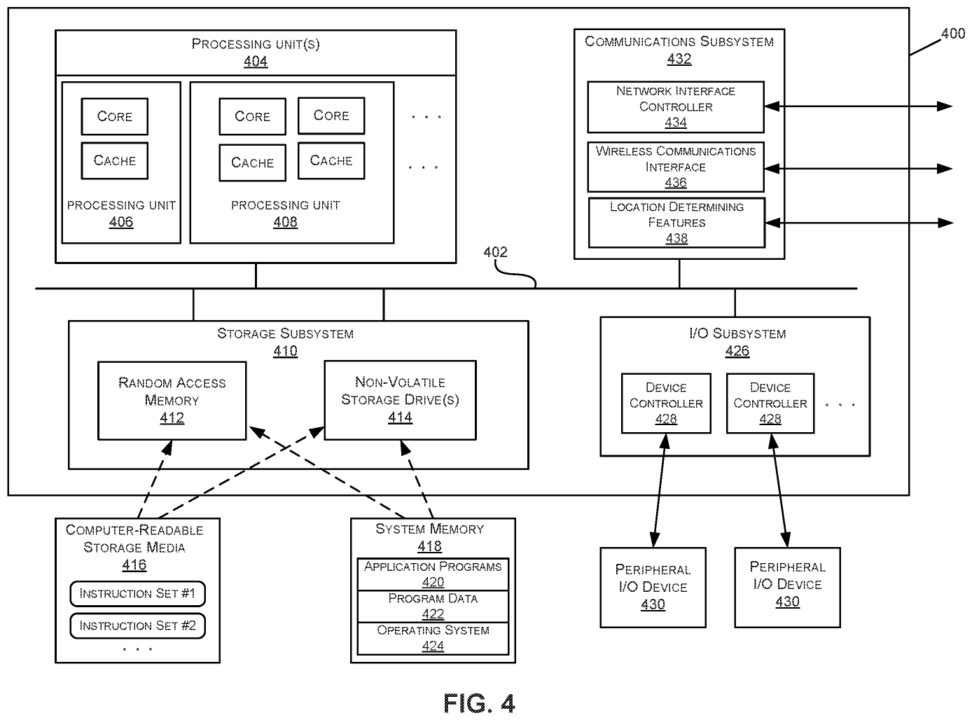

With reference now to FIG. 4, a block diagram of an illustrative computer system is shown. The system 400 may correspond to any of the computing devices or servers of the system 100 described above, or any other computing devices described herein. In this example, computer system 400 includes processing units 404 that communicate with a number of peripheral subsystems via a bus subsystem 402. These peripheral subsystems include, for example, a storage subsystem 410, an I/O subsystem 426, and a communications subsystem 432.

Bus subsystem 402 provides a mechanism for letting the various components and subsystems of computer system 400 communicate with each other as intended. Although bus subsystem 402 is shown schematically as a single bus, alternative embodiments of the bus subsystem may utilize multiple buses. Bus subsystem 402 may be any of several types of bus structures including a memory bus or memory controller, a peripheral bus, and a local bus using any of a variety of bus architectures. Such architectures may include, for example, an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 404, which may be implemented as one or more integrated circuits (e.g., a conventional microprocessor or microcontroller), controls the operation of computer system 400. One or more processors, including single core and/or multicore processors, may be included in processing unit 404. As shown in the figure, processing unit 404 may be implemented as one or more independent processing units 406 and/or 408 with single or multicore processors and processor caches included in each processing unit. In other embodiments, processing unit 404 may also be implemented as a quad-core processing unit or larger multicore designs (e.g., hexa-core processors, octo-core processors, ten-core processors, or greater.

Processing unit 404 may execute a variety of software processes embodied in program code, and may maintain multiple concurrently executing programs or processes. At any given time, some or all of the program code to be executed can be resident in processor(s) 404 and/or in storage subsystem 410. In some embodiments, computer system 400 may include one or more specialized processors, such as digital signal processors (DSPs), outboard processors, graphics processors, application-specific processors, and/or the like.

I/O subsystem 426 may include device controllers 428 for one or more user interface input devices and/or user interface output devices 430. User interface input and output devices 430 may be integral with the computer system 400 (e.g., integrated audio/video systems, and/or touchscreen displays), or may be separate peripheral devices which are attachable/detachable from the computer system 400.

Input devices 430 may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. Input devices 430 may also include three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additional input devices 430 may include, for example, motion sensing and/or gesture recognition devices that enable users to control and interact with an input device through a natural user interface using gestures and spoken commands, eye gesture recognition devices that detect eye activity from users and transform the eye gestures as input into an input device, voice recognition sensing devices that enable users to interact with voice recognition systems through voice commands, medical imaging input devices, MIDI keyboards, digital musical instruments, and the like.

Output devices 430 may include one or more display subsystems, indicator lights, or non-visual displays such as audio output devices, etc. Display subsystems may include, for example, cathode ray tube (CRT) displays, flat-panel devices, such as those using a liquid crystal display (LCD) or plasma display, projection devices, touch screens, and the like. In general, use of the term “output device” is intended to include all possible types of devices and mechanisms for outputting information from computer system 400 to a user or other computer. For example, output devices 430 may include, without limitation, a variety of display devices that visually convey text, graphics and audio/video information such as monitors, printers, speakers, headphones, automotive navigation systems, plotters, voice output devices, and modems.

Computer system 400 may comprise one or more storage subsystems 410, comprising hardware and software components used for storing data and program instructions, such as system memory 418 and computer-readable storage media 416. The system memory 418 and/or computer-readable storage media 416 may store program instructions that are loadable and executable on processing units 404, as well as data generated during the execution of these programs.

Depending on the configuration and type of computer system 400, system memory 318 may be stored in volatile memory (such as random access memory (RAM) 412) and/or in non-volatile storage drives 414 (such as read-only memory (ROM), flash memory, etc.) The RAM 412 may contain data and/or program modules that are immediately accessible to and/or presently being operated and executed by processing units 404. In some implementations, system memory 418 may include multiple different types of memory, such as static random access memory (SRAM) or dynamic random access memory (DRAM). In some implementations, a basic input/output system (BIOS), containing the basic routines that help to transfer information between elements within computer system 400, such as during start-up, may typically be stored in the non-volatile storage drives 414. By way of example, and not limitation, system memory 418 may include application programs 420, such as client applications, Web browsers, mid-tier applications, server applications, etc., program data 422, and an operating system 424.

Storage subsystem 410 also may provide one or more tangible computer-readable storage media 416 for storing the basic programming and data constructs that provide the functionality of some embodiments. Software (programs, code modules, instructions) that when executed by a processor provide the functionality described herein may be stored in storage subsystem 410. These software modules or instructions may be executed by processing units 404. Storage subsystem 410 may also provide a repository for storing data used in accordance with the present invention.

Storage subsystem 410 may also include a computer-readable storage media reader that can further be connected to computer-readable storage media 416. Together and, optionally, in combination with system memory 418, computer-readable storage media 416 may comprehensively represent remote, local, fixed, and/or removable storage devices plus storage media for temporarily and/or more permanently containing, storing, transmitting, and retrieving computer-readable information.

Computer-readable storage media 416 containing program code, or portions of program code, may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 400.

By way of example, computer-readable storage media 416 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 416 may include, but is not limited to, Zip® drives, flash memory cards, universal serial bus (USB) flash drives, secure digital (SD) cards, DVD disks, digital video tape, and the like. Computer-readable storage media 416 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 400.

Communications subsystem 432 may provide a communication interface from computer system 400 and external computing devices via one or more communication networks, including local area networks (LANs), wide area networks (WANs) (e.g., the Internet), and various wireless telecommunications networks. As illustrated in FIG. 4, the communications subsystem 432 may include, for example, one or more network interface controllers (NICs) 434, such as Ethernet cards, Asynchronous Transfer Mode NICs, Token Ring NICs, and the like, as well as one or more wireless communications interfaces 436, such as wireless network interface controllers (WNICs), wireless network adapters, and the like. Additionally and/or alternatively, the communications subsystem 432 may include one or more modems (telephone, satellite, cable, ISDN), synchronous or asynchronous digital subscriber line (DSL) units, FireWire® interfaces, USB® interfaces, and the like. Communications subsystem 436 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

The various physical components of the communications subsystem 432 may be detachable components coupled to the computer system 400 via a computer network, a FireWire® bus, or the like, and/or may be physically integrated onto a motherboard of the computer system 400. Communications subsystem 432 also may be implemented in whole or in part by software.

In some embodiments, communications subsystem 432 may also receive input communication in the form of structured and/or unstructured data feeds, event streams, event updates, and the like, on behalf of one or more users who may use or access computer system 400. For example, communications subsystem 432 may be configured to receive data feeds in real-time from users of social networks and/or other communication services, web feeds such as Rich Site Summary (RSS) feeds, and/or real-time updates from one or more third party information sources. Additionally, communications subsystem 432 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 432 may output such structured and/or unstructured data feeds, event streams, event updates, and the like to memory 124 that may be in communication with one or more streaming data source computers coupled to computer system 400.

Due to the ever-changing nature of computers and networks, the description of computer system 400 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

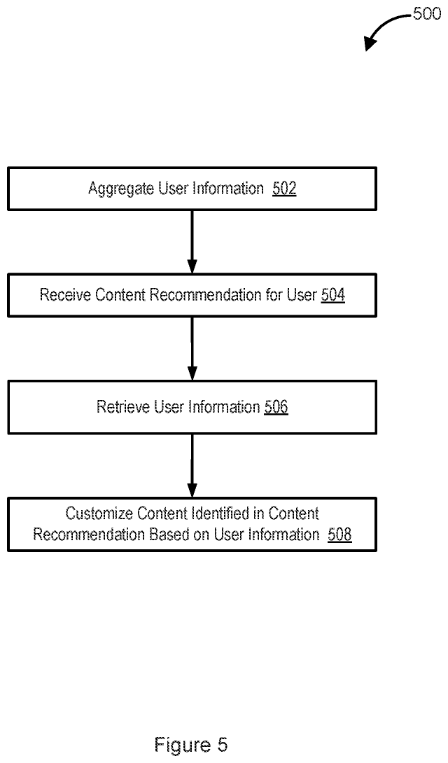

With reference now to FIG. 5, a flowchart illustrating one embodiment of a process 500 for book customization, and specifically for customization of content of a book is shown. In some examples, one or several processors or servers 122, server 202, or processing unit 402 can perform one or more of the steps shown in FIG. 5. In other examples the one or several processors or servers 122, the server 202, or the processing unit 402 can implement more steps, fewer steps, different steps, or a different order of the steps depicted in FIG. 5. The steps of FIG. 5 are described below with reference to components discussed above in FIGS. 1-4.

This book customization of the process 500 can include customization of textual content, customization of graphical content, customization of audio content, and/or customization of video content. This can include the generation of a reader profile, including pictures of the reader, reader's friends, reader's pets, and/or reader's family. Based on this profile, a custom book is automatically generated for the reader. This can include selecting subject matter of interest to the reader, insertion of names associated with the reader into the book, and/or the generation of one or several artistic representations of the reader, the reader's friends, the reader's pets, and/or one or several members of the reader's family, and inserting these representations into the book. This can further include the training of an ML model that can pull together attributes from the user profile and attributes of the user (e.g., location, school, etc.), to auto generate the book.

The process 500 begins at block 502, wherein user information is aggregated. In some embodiments, this user information can include data files. In some embodiments, these data files can include biographical information relating to the user. For example, the information can include the user's interests (e.g., hobbies, reading content preferences, learning preferences, etc.), personal data for the user (e.g., name, age, gender, etc.), location data (e.g., a home address or a school address), or other suitable information relating to the user. The data files can further include at least one image. In some embodiments, the image can be an image of the user. The user information can further include data files with information relating to or images of family or friends of the user. This user information can be aggregated and stored in the memory 124, and specifically within the profile store 128. The data files can be stored in the profile store 128 in association with a user profile of the user. Thus, the information stored in the data files may be displayed at or otherwise accessible via the user profile contained in the profile store 128.

At block 504, a content recommendation is received for the user. In some embodiments, the content recommendation can be generated via a machine learning (ML) model based on the user information relating to the user contained in the user profile contained in the profile store 128. For example, the model store 126 can include a ML model trained to output the content recommendation in response to receiving one or more of the data files corresponding to the user. The content recommendation may include a genre (e.g., fantasy, mystery, science fiction, biography, etc.), a book type (e.g., chapter book, graphic novel, short story, etc.), content for personal customization of the book (e.g., a sport or other suitable hobby of interest to the user, a name of the user, names of friends or family of the user, a type and name of a pet, etc.), or other suitable information which characterizes book types and content of interest to the user. The ML model can be trained to output the content recommendation using a dataset comprising user profiles, which can include user data for various user attributes (e.g., age, gender, hobbies, reading level, learning preference, etc. of the users), and corresponding content preferences of the users. As a result of training the ML model, the content recommendation can be made based on a user skill level, user interests (e.g., hobbies, genres of interest, etc.), learning preferences, or a combination thereof. The ML model can involve linear regression, logistic regression, one or more decision trees, one or more neural networks, other suitable machine learning techniques or a combination thereof.

Additionally, in some examples, the content recommendation can be for content in the content store 130. For example, the content store 130 can include content for presentation to one or several users. The content can include text, images, animations, video, audio, or the like. Thus, in some examples, the ML model can select content best suited for the user based on the user information. Alternatively, there can be a first ML model trained to output the genre, book type, and content based on the user information. Then, a second ML model can be implemented to select the book or set of books based on the genre, book type, and content. Either way, to output the book or set of books, the ML model can use collaborative filtering, content-based filtering, matrix factorization techniques, deep learning models (e.g., a convolution neural network (CNN)), knowledge-based systems, ensemble methods, other suitable ML techniques, or a combination thereof.

Alternatively, the content recommendation can be an artificial intelligence (AI) generated book. For example, the ML model can generate the AI generated book based on the user information. Alternatively, there can be a first ML model trained to output the genre, book type, and content based on the user information. Then, a second ML model can generate the AI generated book based on the genre, book type, and content. Either way, to generate the AI generated book, a large language model, recurrent neural network, long-short term memory networks, gated recurrent units, or other suitable types of generative models can be used.

At block 506, user information is received. In some embodiments, the user information is received by the server 122 from the memory 124, and specifically from the profile store 128. As noted above, the information retrieved by the server 122 from the profile store 128 can include information indicative of the user's interests (e.g., hobbies, reading content preferences, learning preferences, etc.), personal data for the user (e.g., name, age, gender, etc.), location data (e.g., a home address or a school address), or other suitable information relating to the user. The user information can further include an image of the user or images related to the user (e.g., images of friends and family, an image of a family pet, images of characters, sports, artists, etc. of interest to the user, or other suitable images). The user information can further include information relating to family or friends of the user. The information relating to family or friends can include names, ages, hobbies, etc. of the family members and friends.

At block 508, the content corresponding to the content recommendation is customized based on the user information. In some embodiments, customizing the content includes customizing at least one textual aspect of the content and at least one graphical aspect of the content. In an example, the content store 130 can include various books and the content recommendation can be a particular book. In the example, customizing a textual aspect may involve changing a name of at least one character in the book to a name in the user information (e.g., a name of the user or of a friend, family member, or pet) or changing other textual aspects of the book. Additionally, the book may involve a character being in a particular location and/or performing a task (e.g., playing a sport or instrument). Thus, customizing other textual aspects can include altering an identifier of the location or a task, a description of the location or task, or a combination thereof. Because the content recommendation is made based on the user information, the task may, for example, correspond to a hobby of the user and the location may, for example, correspond to a region in which the user lives. Additionally, customizing a graphical aspect of the content may involve altering an appearance of at least one character to have one or more similarities to the user, friends or family of the user, or the like. The graphical aspect can be altered based on the user information or images. For example, altering an appearance of a character may involve making the character appear older or younger based on an age of the user. In another example, a character's features (e.g., eye color, hair length, skin color, etc.) can be altered to cause the character to appear similar to the user or a friend or family member. Similarly, textual aspects of an AI generated book can be customized based on the user information. Additionally, images can be added to or altered the AI generated book based on the user information or images.

In some embodiments, customizing the content can include identifying at least one static portion of the content and at least one dynamic portion of the content. The static portion of the content can be elements of the content that remain constant each time the content is accessed. For example, if the content is a book, the static portions can include the font size, page layout, story line, etc. The dynamic portions of the content can be elements of the content that may change in response to user interactions or user input. For example, the user input can be speech received at a user device of the user reading aloud, selections of user preferences for the story, or the like. Customizing the content may then include determining an attribute of the dynamic portion of the content. For example, the attribute of the dynamic portions can be character features, vocabulary words, or other suitable attributes of the dynamic portions of the content. User information may then be selected based on the attribute of the dynamic portion of the content. For example, if the attribute of the dynamic portion is a character feature, the personal data or other suitable user information can be selected. Similarly, if the attribute of the dynamic portion is one or more vocabulary words, a user skill level or learning preferences can be selected. The dynamic portion of the content can then be modified according to the selected user information. For example, the vocabulary words can be modified to correspond with a user skill level or character attributes can be modified to be similar to the user (e.g., an age of the character can be changed to the age of the user).

In some embodiments, customizing content includes ingesting information into a ML model trained for automated content generation. This information can include at least portions of the user information, one or several plot attributes, and a desired skill level of the generated text. Customizing content can further include receiving an output from the ML model (e.g., receiving the AI generated book from the large language model or other suitable generative model) and validating the output of the ML model. Validating the output can involve assessing the output to determine whether it can be used for its intended purpose (e.g., presented to a user for consumption). For example, the AI generated book can be assessed for its technical accuracy, coherence, creativity, grammar, or the like. To perform validation of the output, natural language processing tools, grammar checking software, plagiarism detection tools, or the like can be used.

In some embodiments, customizing the content identified can include generating an avatar representing the user based on at least one image of the user information. In some embodiments, the avatar representing the user can be used to customize the at least one graphical aspect of the content. In some embodiments, customizing the content identified can include generating at least one avatar representing one of a user family member, a user pet, and a user friend. In some embodiments, customizing the at least one textual aspect of the content includes modifying aspects of a plot based on user information. In some embodiments, modifying aspects of the plot based on user information includes modifying at least one character name to match a name identified in the user information. In some embodiments, modifying aspects of the plot based on user information includes matching at least one aspect of the plot to correspond to a user interest identified in the user information.

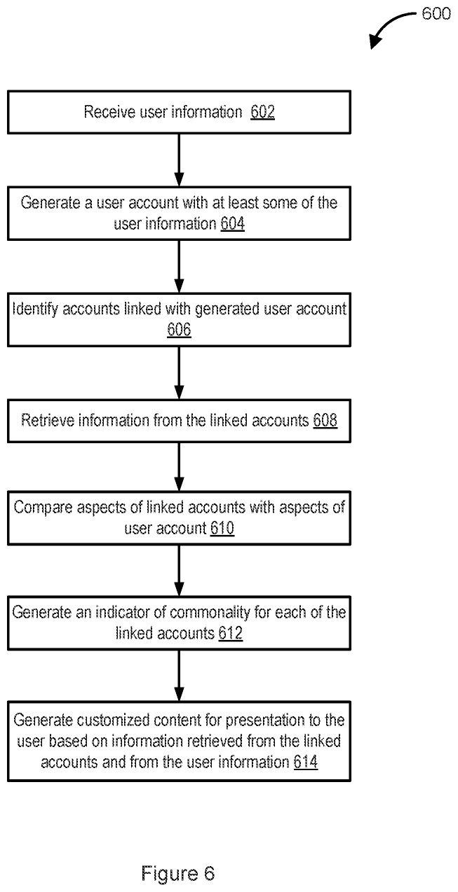

With reference now to FIG. 6, a flowchart illustrating a process 600 for creating a social-networked content distribution system. In some examples, one or several processors or servers 122, server 202, or processing unit 402 can perform one or more of the steps shown in FIG. 6. In other examples the one or several processors or servers 122, the server 202, or the processing unit 402 can implement more steps, fewer steps, different steps, or a different order of the steps depicted in FIG. 6. The steps of FIG. 6 are described below with reference to components discussed above in FIGS. 1-4.

In some embodiments, social-networked content distribution system can be initially generated based on information provided by and/or gathered from the reader, and identifying people linked with the reader. These can include, friends, family, classmates, teammates, etc. Connections are generated based on this information. Depending on the closeness of the connection, and the content of a book, a book custom generated for an individual in linked with the reader will be made available to the reader. This can include making books available to the reader in which the reader or a reader contact appears as a character, and/or making books available to the reader in which something related to the reader appears (e.g., the reader's soccer team appears). This leverages book customization to provide multiple uses of a custom book.

The process 600 begins at block 602, wherein user information is received. The user information can identify a user and include the user's interests (e.g., hobbies, reading content preferences, learning preferences, etc.), personal data for the user (e.g., name, age, gender, etc.), location data (e.g., a home address or a school address), or other suitable information relating to the user. In some embodiments, the user information can further include a plurality of other individuals connected with the user. In some embodiments, this user information can be received by the server 122 from, for example, the user device 108, and can be stored in the memory 124, and specifically in the profile store 128.

At block 604, a user account is generated. In some embodiments, the user account can be generated with at least some of the user information. In some embodiments, the user account can be generated with some or all of the user information. In some embodiments, the user account can be generated by the server 122 and can be stored in the memory 124, and specifically in the profile store 128.

At block 606, one or several accounts are identified that are linked with the generated user account. In some embodiments, the generated user account can be linked with other user accounts. In some embodiments, the user account can be linked with user accounts of at least some of the other individuals connected with the user. The other individuals can be connected to the user via, for example, family relationship, friendship, school class, sports team, or the like.

Additionally, in some embodiments, to identify the one or several accounts that are linked with the generated user account, the process may involve identifying user information in each of the user accounts that at least partially matches information in the generated user account. For example, user information in the one or several user accounts can match a last name, school, sports team, etc. included in the user information of the generated user account. In some embodiments, one or several accounts can be identified by the server 122 and can be stored in the memory 124, and specifically in the profile store 128.

At block 608, information from the linked accounts is received. In some embodiments, the information retrieved from the linked accounts can include, personal data, location data, learning preferences, school information, hobby information, or other suitable information. Additionally, in some embodiment, the information from the linked accounts can include a plurality of images.

At block 610, aspects of the linked accounts are compared to aspects of the generated user account. In some embodiments, for example, aspects of the user accounts of other individuals linked to the user at block 606 can be compared to aspects of the generated user account. In some embodiments, this can include comparing interests of users of the linked accounts with the interests of the user for whom the user information was received and/or comparing content previously liked by the users of the linked accounts with content previously liked by the user for whom the user information was received.

At block 612, an indicator of commonality for each of the linked accounts is identified.

In some embodiments, the indicator of commonality indicates a strength of connection between the user and each user of a linked account. In some embodiments, a machine learning (ML) model can be trained to output the indicator of commonality (e.g., a value between 0 and 100) that indicates the strength of the connection between the user and each user of each of the linked accounts. For example, the ML model can be trained on user information and corresponding indicators of commonality. Thus, the ML model may take the user information from the generated user account and user information from a linked account as input and output the indicator of commonality in response. In some examples, a value closer to 100 can indicate a greater strength of connection between users than a value closer to 0. In some embodiments, block 612 can include identifying commonalities between the user account and users of linked accounts. The commonalities can include a hobby, school, mutual friends or user account links, or the like.

At block 614, customized content is generated based on the information retrieved from the linked accounts and at least portions of the user information. In some embodiments, generating the customized content can include generating a plurality of avatars based on the retrieved images from the different accounts. In some embodiments, each of the avatars represents a user of one of the linked accounts. In some embodiments, the customized content can be generated based at least in part on the identified commonalities. In some embodiments, generating content based at least in part on the identified commonalities can include generating an indicator of commonality between the user and each user of a linked account.

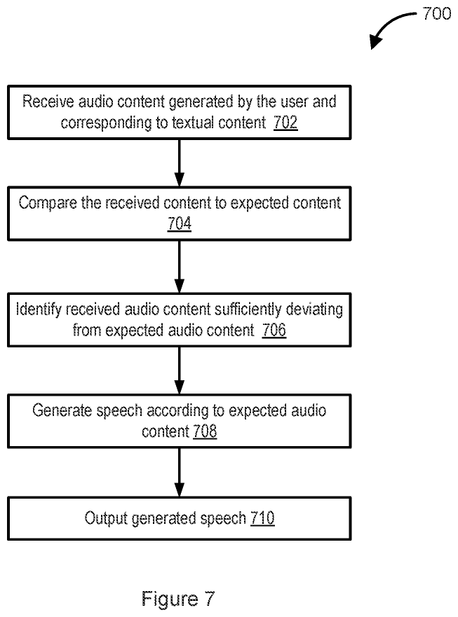

With reference now to FIG. 7, a flowchart illustrating one embodiment of a process 700 for a listening and self-correcting book is shown. In some examples, one or several processors or servers 122, server 202, or processing unit 402 can perform one or more of the steps shown in FIG. 7. In other examples the one or several processors or servers 122, the server 202, or the processing unit 402 can implement more steps, fewer steps, different steps, or a different order of the steps depicted in FIG. 7. The steps of FIG. 7 are described below with reference to components discussed above in FIGS. 1-4.

The process 700 can include listening to a reader reading a book, to evaluate the reading, and to automatically provide corrections and/or assistance. This includes customizing corrections based on attributes of the reader such as age, gender, geographic region, ethnicity, etc. In other words, corrections are customized to mimic the reader such as by, for example, matching an accent or pronunciation corresponding to the reader or selected by the reader. This can further include sentiment analysis to determine reader confidence or automatic generation of content for the reader based on the corrections provided to the reader.

The process 700 begins at block 702, wherein audio content generated by the user and corresponding to textual content is received. In some embodiments, the audio content can include read content. The read content can be textual or written content from a printed book, eBook, or other suitable document which is read aloud by the user. The audio content may therefore be speech from the user and may be received by one or more speakers, microphones, or other suitable portions of an I/O system 106 of a book 102.

At block 704, the received audio content is compared to expected content. The expected content can be expected audio content or expected textual content. For example, a server 122 may store an expected audio file, which may be generated via a text-to-speech model or recorded by a user via the I/O system 106 or a user device, text files, or a combination thereof for the printed book, eBook, or other suitable document in a content store 130.

In some embodiments, the received audio content is compared to expected content via a machine learning (ML) model and/or a ML algorithm. The ML model or algorithm used to compare the received audio content and the expected content can be or involve an automatic speech recognition algorithm, which may use deep learning and/or convolutional neural networks, an autoencoder, or other suitable ML models or algorithms which can be used for speech recognition and/or natural language processing.

In some examples, the ML model or algorithm can take features of the received audio content, features of the expected content, or a combination thereof as input. Thus, comparing the received audio content and the expected content can involve extracting features from the received audio content, extracting features from the expected content, or a combination thereof. For example, the server 122 can extract spectral features (e.g., Mel-frequency cepstral coefficients, fundamental frequency, spectral bandwidth, formants, spectral centroid, spectral contrast, etc.) and temporal features (e.g., temporal envelope, duration, phoneme duration, energy, zero-crosse rate, etc.) from the received audio content and from the expected audio content. The features can then be input into the ML model or algorithm. In an example, the ML model can be trained to output a deviation value indicative of an amount of deviation of the received audio content from the expected audio content based on the features. For example, the ML model can output a value between zero and one hundred, where values closer to one-hundred may correspond to a higher amount of deviation. The machine learning model can be trained on a data set comprising pairs of feature sets and corresponding deviation values.

In some examples, comparing the audio content and the expected content can further involve comparing phonemes of the received and expected content. For example, a ML model or algorithm may be trained to identify a first set of phonemes for the expected audio content, a second set phonemes for the received audio content, or a combination thereof based on the temporal and spectral features. The first set of phonemes and the second set of phonemes can then be compared. In some examples, the sets of phonemes can be in a particular order corresponding to the received and expected audio. Thus, comparing the sets of phonemes may involve identifying phonemes in the second set of phonemes that are excluded from or are in a different order than phonemes of the first set of phonemes. A number of phonemes that are excluded from or are in an incorrect order can be a feature input into the ML model trained to output the deviation value.

In another example, a speech-to-text model can be used to transcribe the received audio content into textual content. Once transcribed, the textual content can be compared to the expected textual content to determine a minimum number of operations required to transform the textual content into the expected textual content. The operations can involve inserting, deleting, or replacing a character or space in the textual content. The minimum number of operations required can be another feature input into the machine learning model trained to output the deviation value. Thus, in some examples, the ML model can output the deviation value based on the features of the received audio content, features of the expected audio content, the minimum number of operations, the number of phonemes, or a combination thereof.

At block 706, received audio content deviating from expected audio content by greater than a threshold value is identified. For example, the ML model can output the deviation value indicative of the amount of deviation of the received audio content from the expected audio content based on the features. Based on the deviation value being greater than the threshold value, the received audio content deviating from the expected audio can be identified.

At block 708, speech is generated, which speech corresponds to the expected audio content. In some embodiments, the speech corresponding to the expected audio content is generated based at least on one attribute of the user. The speech can be generated by a ML model, such as a text-to-speech model. In some embodiments, the at least one attribute of the user includes a gender, age, location, spoken dialect, accent, other suitable attributes, or a combination thereof of the user. Additionally, in some examples, the speech can be generated with a similar pitch, timbre, rhythm, or other suitable characteristics of the user or of an associated user (e.g., teacher, family member, celebrity, etc.) to cause the generated speech to mimic the voice of the user or the associated user.

In some embodiments, and as indicated in block 710, the generated speech is output to the user. For example, the generated speech can be output via a speaker of the I/O system 106.

In some examples, the I/O system 106 can receive audio content while the user is reading aloud. Thus, I/O system 106 may input each audio content for a particular duration or corresponding to a word, fragment, sentence, or another suitable segment of content into the ML algorithm. Alternatively, the machine learning algorithm can be trained to identify each word, fragment, sentence, or other suitable segment of content. As a result, in some examples, deviation values may be generated continuously for each segment of content while the user is reading aloud. Then, when a deviation value greater than the threshold value is generated, the I/O system 106 can flag the portion of received audio content as deviating from a corresponding portion of the expected audio content, generate speech for the expected audio content, and output the speech to the user.

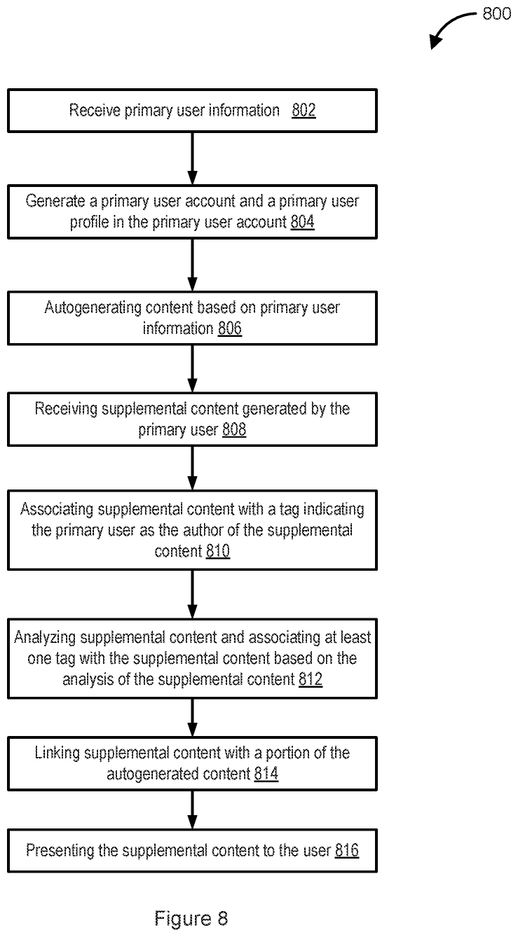

With reference now to FIG. 8, a flowchart illustrating one embodiment of a process 800 for generating and providing a living book is shown. In some examples, one or several processors or servers 122, server 202, or processing unit 402 can perform one or more of the steps shown in FIG. 6. In other examples the one or several processors or servers 122, the server 202, or the processing unit 402 can implement more steps, fewer steps, different steps, or a different order of the steps depicted in FIG. 6. The steps of FIG. 6 are described below with reference to components discussed above in FIGS. 1-4.

The process 800 can include the creation of a multiplayer and/or multiuser interactive book. In some embodiments, such a book can allow multiple people to simultaneously interact with a book. In some embodiments, the process 800 can create the ability for multiple people to upload content associated with the book, while those people are interacting with the book to thereby create a live-stream of interaction. This content can include notes, messages, pictures. In some embodiments, some portion of the books can be alterable by the user to change the plot of the book, the story of the book, illustrations of the book, or the like. In some embodiments, this can be applicable for a book of any subject. For example, in math, you could upload working through a problem and identifying a sticking point, or explaining something relating to the problem.

The process begins at block 802, wherein primary user information is received and/or retrieved. In some embodiments, this information can be received and/or retrieved from the user via the user device 108 and/or the book 102.

At block 804, a primary user account is generated and a primary user profile is generated in the primary user account. In some embodiments, the primary user account can be generated based on information received and/or retrieved in block 802.

At block 806, content is autogenerated based on information relating to a primary user.

In some embodiments, this content can autogenerated and/or customized as outlined in the process 500 of FIG. 5. In some embodiments, the autogenerated content is presented to the primary user for consumption.

At block 808, supplemental content is received. In some embodiments, the supplemental content is received while the primary user is consuming the autogenerated content. In some embodiments, the supplemental content is generated by the primary user and linked with the autogenerated content. In some embodiments, the supplemental content can include at least one of: a video, an image, and text.

At block 810, the supplemental content is associated with a tag. In some embodiments, the tag can indicate the primary user as the author of the supplemental content. At block 812, the supplemental content is analyzed, and/or one or several tags are associated with the supplemental content based on the analysis of the supplemental content. In some embodiments, these one or several tags can identify one or several attributes of the supplemental content such as, for example, the subject matter of the supplemental content, the type of the supplemental content (e.g., text, video, audio, etc.), or the like.

At block 814, the supplemental content is linked with the portion of the autogenerated content relevant to the supplemental content.

At block 816, the supplemental content is made available to at least one additional user linked with the primary user and/or is presented to the user. In some embodiments, this can include selecting at least portions of the supplemental content for delivery to the at least one additional user based on the one or several tags associated with the supplemental content and an attribute of the at least one additional user.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method for automated reader feedback, the method comprising:
receiving audio content generated by a user and corresponding to textual content provided to the user, the audio content comprising read content;
comparing the received audio content to expected audio content via a machine learning algorithm;
determining, based on an output of the machine learning algorithm, that a portion of the received audio content deviates from a portion of the expected audio content by greater than a threshold value;
generating speech corresponding to the portion of the expected audio content, wherein the speech corresponding to the portion of the expected audio content is generated based at least on one attribute of the user; and
outputting the generated speech to the user.

2. The method of claim 1, wherein the output of the machine learning algorithm is a deviation value indicative of an amount of deviation of the portion of the received audio control from the portion of the expected audio content, and wherein determining that the portion of the received audio content deviates from the portion of the expected audio content by greater than the threshold value comprises determining that the deviation value exceeds the threshold value.

3. The method of claim 1, where comparing the received audio content to the expected audio content via the machine learning algorithm comprises:
extracting a first plurality of features from received audio content;
extracting a second plurality of features from the expected audio content; and
inputting the first plurality of features and the second plurality of features into the machine learning algorithm.

4. The method of claim 3, wherein the machine learning algorithm is a first machine learning algorithm, and wherein the method further comprises:
inputting the first plurality of features and the second plurality of features into a second machine learning algorithm trained to identify phonemes;
outputting, by the second machine learning algorithm, a first set of phonemes for the received audio content and a second set of phonemes for the expected audio content;
identifying a number of phonemes in the first set of phonemes that are excluded from the second set of phonemes; and
inputting the number of phonemes into the first machine learning algorithm.

5. The method of claim 1, wherein the textual content is first textual content, and wherein the method further comprises:
transcribing, via a speech-to-text model, the received audio content into second textual content;
comparing the second textual content to the first textual content to determine a minimum number of operations to transform the second textual content into the first textual content; and
inputting the minimum number of operations into the machine learning algorithm.

6. The method of claim 1, wherein the at least one attribute of the user comprises a location.

7. The method of claim 1 wherein the at least one attribute of the user comprises a spoken dialect.

8. The method of claim 1, wherein the at least one attribute of the user comprises an accent.

9. A system comprising:
a processor; and
a memory that includes instructions executable by the processor for causing the processor to perform operations comprising:
receiving audio content generated by a user and corresponding to textual content provided to the user, the audio content comprising read content;
comparing the received audio content to expected audio content via a machine learning algorithm;
determining, based on an output of the machine learning algorithm, that a portion of the received audio content deviates from a portion of the expected audio content by greater than a threshold value;
generating speech corresponding to the portion of the expected audio content, wherein the speech corresponding to the portion of the expected audio content is generated based at least on one attribute of the user; and
outputting the generated speech to the user.

10. The system of claim 9, wherein the output of the machine learning algorithm is a deviation value indicative of an amount of deviation of the portion of the received audio control from the portion of the expected audio content, and wherein the operation of determining that the portion of the received audio content deviates from the portion of the expected audio content by greater than the threshold value comprises determining that the deviation value exceeds the threshold value.

11. The system of claim 9, wherein the operation of comparing the received audio content to the expected audio content via the machine learning algorithm comprises:
extracting a first plurality of features from received audio content;
extracting a second plurality of features from the expected audio content; and
inputting the first plurality of features and the second plurality of features into the machine learning algorithm.

12. The system of claim 11, wherein the machine learning algorithm is a first machine learning algorithm, and wherein the operations further comprise:
inputting the first plurality of features and the second plurality of features into a second machine learning algorithm trained to identify phonemes;
outputting, by the second machine learning algorithm, a first set of phonemes for the received audio content and a second set of phonemes for the expected audio content;
identifying a number of phonemes in the first set of phonemes that are excluded from the second set of phonemes; and
inputting the number of phonemes into the first machine learning algorithm.

13. The system of claim 9, textual content is first textual content, and wherein the operations further comprise:
transcribing, via a speech-to-text model, the received audio content into second textual content;
comparing the second textual content to the first textual content to determine a minimum number of operations to transform the second textual content into the first textual content; and
inputting the minimum number of operations into the machine learning algorithm.

14. The system of claim 9, wherein the at least one attribute of the user comprises a location.

15. The system of claim 9, wherein the at least one attribute of the user comprises a spoken dialect.

16. A non-transitory computer-readable medium comprising instructions that are executable by a processor for causing the processor to perform operations comprising:
receiving audio content generated by a user and corresponding to textual content provided to the user, the audio content comprising read content;
comparing the received audio content to expected audio content via a machine learning algorithm;
determining, based on an output of the machine learning algorithm, that a portion of the received audio content deviates from a portion of the expected audio content by greater than a threshold value;
generating speech corresponding to the portion of the expected audio content, wherein the speech corresponding to the portion of the expected audio content is generated based at least on one attribute of the user; and
outputting the generated speech to the user.

17. The non-transitory computer-readable medium of claim 16, wherein the output of the machine learning algorithm is a deviation value indicative of an amount of deviation of the portion of the received audio control from the portion of the expected audio content, and wherein the operation of determining that portion of the received audio content deviates from expected audio content by greater than the threshold value comprises determining that the deviation value exceeds the threshold value.

18. The non-transitory computer-readable medium of claim 16, wherein the operation of comparing the received audio content to the expected audio content via the machine learning algorithm comprises:
extracting a first plurality of features from received audio content;
extracting a second plurality of features from the expected audio content; and
inputting the first plurality of features and the second plurality of features into the machine learning algorithm.

19. The non-transitory computer-readable medium of claim 18, wherein the machine learning algorithm is a first machine learning algorithm, and wherein the operations further comprise:
inputting the first plurality of features and the second plurality of features into a second machine learning algorithm trained to identify phonemes;
outputting, by the second machine learning algorithm, a first set of phonemes for the received audio content and a second set of phonemes for the expected audio content;
identifying a number of phonemes in the first set of phonemes that are excluded from the second set of phonemes; and
inputting the number of phonemes into the first machine learning algorithm.

20. The non-transitory computer-readable medium of claim 16, textual content is first textual content, and wherein the operations further comprise:
transcribing, via a speech-to-text model, the received audio content into second textual content;
comparing the second textual content to the first textual content to determine a minimum number of operations to transform the second textual content into the first textual content; and
inputting the minimum number of operations into the machine learning algorithm.
